(19) United States
(12) Patent Application Publication
(10) Pub. No.: US 2007/0011116 A1
(43) Pub. Date: Jan. 11, 2007

(54) Method of updating revocation list

(75) Inventor: Marc Vauclair, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,381

(22) PCT Filed: Apr. 26, 2004
(86) PCT No.: PCT/IB04/50515

§ 371 Date: Oct. 25, 2005

(30) Foreign Application Priority Data
Apr. 28, 2003 (EP) 03101153.9

(51) Int. Cl. G06F 15/18

(52) U.S. Cl. 706/16

(57) ABSTRACT

This invention proposes a method, system, and device to update a revocation list, receive an update for the revocation list, and make a random decision to either update the list with the update or to ignore it.

The invention relates to a method of facilitating access control to content, the method involving entities being identified by a unique identifier, the method further involving revocation of at least one unique identifier, where a revoked unique identifier is further referred to as revoked identifier, the method comprising maintaining a local revocation list that contains a list of revoked identifiers, receiving a new revoked identifier, and subsequently updating the local revocation list with the received new revoked identifier.

The invention further relates to a system for controlling access to content material, the system comprising a local revocation list that contains a list of revoked identifiers, a receiver for receiving a new revoked identifier, and an updater for conditionally updating the local revocation list with the received new revoked identifier.

The invention further relates to a device arranged to store and maintain a local revocation list that contains a list of revoked identifiers, and to receive a new revoked identifier.

The invention further relates to a computer program product capable to implement the method described above.

Digital content, such as movies, television programs, music, text, and the like, can be copied repeatedly without quality loss. Copy protection is being used by the content owners to prevent unlimited copying. Also, content access control technology is being used in order to control which content can be accessed by the user, in which manner, and against which conditions. Systems implementing content access control technology are known as conditional access systems (CA) in the broadcast world, and as DRM (Digital Rights Management) in the Internet world.

Different technologies have been proposed, developed, or used to implement copy protection and content access control. Content material can be encrypted during transmission and/or when it is being recorded. Devices that are designed to decrypt and render encrypted content, should comply with the policy associated with the content. An example policy is to transfer content only to a different device if that different device is also compliant.

Recently new content protection systems have been introduced in which a set of devices can authenticate each other through a bi-directional connection. Examples of these systems are SmartRight from Thomson, and DTCP (Digital Transmission Content Protection, http://www.dtcp.com) from the Digital Transmission Licensing Administration (DTLA). Based on this authentication, the devices will trust each other and this will enable them to exchange protected content. The trust is based on some secret, only known to devices that were tested and certified to have secure implementations. Knowledge of the secret is tested during the authentication protocol. The best solutions for these protocols are those which employ ‘public key’ cryptography, which use a pair of two different keys. The secret to be tested is then the secret key of the pair, while the public key can be used to verify the results of the test. Additionally, the public key can be used as a unique identifier to refer to the device. To ensure the correctness of the public key and to check whether the key-pair is a legitimate pair of a certified device, the public key is accompanied by a certificate, that is digitally signed by a Certification Authority, the organization which manages the distribution of public/private key-pairs for all devices. In a simple implementation the public/private key pair of the Certification Authority is hard-coded into the implementation of the device.

In typical security scenarios, there are several different devices involved within a system, which might not all be implemented with equal levels of tamper-proofing. Such a system should therefore be resistant to the hacking of individual devices. An attacker can discover and expose the private key of a certified consumer device. Once a key is known, the protocols can be attacked and the content copied directly from the connection or link, enabling uncontrolled and possibly illegal storing, copying and/or redistribution of digital content. A hacker can further copy or imitate the behavior of a valid device. He can also copy the device itself. This way, multiple devices with the same secret can be created.

An important technique to increase the resistance against hacking and illegally copied devices is the so-called revocation of hacked devices. Revocation means the withdrawal of the trust in such a hacked device. If every device contains a unique identifier, it is possible that only the device that has been attacked is disabled by means of revocation. The effect of revocation is that other devices in the network may change their behavior towards the revoked device. For example, they may no longer want to communicate with the revoked device.

Devices can be addressed by unique identifiers. In addition, other entities may also be addressed and optionally revoked by means of a unique identifier.

Revocation of an entity or device can be achieved by using a so-called revocation list, which is a list of identifiers of revoked entities. Identifiers of revoked entities are further referred to as revoked identifiers. Often, revoked identifiers will be accompanied by metadata such as a timestamp. A device that is to verify the trust of another device, needs to have an up-to-date version of the revocation list and needs to check whether the identifier of the other device is on that list. Revocation lists can be published and/or updated by one or more authorities. So-called revocation notices contain updated or new information about revoked identifiers. Revocation lists and revocation notices can be transmitted in a television program or by broadcast servers. They can also be added to a storage medium such as a DVD disk, or communicated over a network. Within a local network, they can be further distributed. Further distribution may include processing or selection steps based on the locally available knowledge about identifiers of connected devices.

One of the known implementations of a revocation list is to use a so-called black list of revoked identifiers. Other implementations use a white list of non-revoked identifiers or mixed solutions. The advantage of black lists is that the entities are trusted by default and the trust in them is only revoked, if their identifier is listed on the black list. Although a device might request an up-to-date version of the black list each time it is needed, in most cases a device stores a local revocation list for referencing in between updates of the list or for local processing. This enables access to the list even if the connection to a server is unavailable, for example because the connection is prone to hacker intervention or hacker interruption, unreliable, sometimes unavailable (e.g., to a wireless mobile device), or too slow.

The revocation list will initially be very small, but it can potentially grow unrestrictedly. Therefore the storage on CE devices of the revocation list might be problematic in the long run.

Normally, storage of the revoked entries shall first fill empty space in the revocation list. Overflow occurs when the storage available for the revocation list is fully used and a new revocation notice is received.

Patent application WO 01/11819A1 describes a procedure of handling overflow in a device with a revocation list. It describes a system comprising a local revocation list that contains a plurality of revoked identifiers, a receiver that receives at least one revoked identifier, and a replacer that randomly replaces at least one revoked identifier of the plurality of revoked identifiers with the at least one new revoked identifier. In accordance with one aspect of that procedure, the replacer is configured to randomly replace a previous entry in the revocation list with each received revoked identifier. By using a random replacement technique, even if not purely random, the likelihood of a particular revoked identifier being present in the list is substantially less determinable than prior methods such as first-in-first-out, newest-in-oldest-out, and other conventional ordered list management techniques. Thus, an adversary cannot rely on the mere passage of time to foil the limited security provided by a limited sized local revocation list.

However, a hacker may still attempt to flood a device with lots of arbitrary revocation notices, which ultimately leads to flushing the complete list.

It is an object of the invention to provide a method of the kind set forth that further reduces the determinability of the device storing the revocation list.

This object is achieved by a method according to the invention characterized in that the method further comprises an admission step including taking a random decision before updating the local revocation list, the decision being either to ignore the received new revoked identifier, or to update the local revocation list with the received new revoked identifier.

Not every new revoked identifier will automatically lead to the replacement of an already stored identifier. This makes it more difficult for a hacker to flush the revocation list already available in the device.

The local revocation list can be used to verify an identifier of one or more entities, such as a device identifier.

The probability of the random decision can be influenced by the result of a comparison between the received new revoked identifier and the list of unique identifiers that has been collected during the verification processes.

The probability of the random decision can be based on one or more characteristics of the received new revoked identifier(s), the device status, or the current local revocation list.

For example, when the frequency of new notifications increases unexpectedly, hacker activity could be suspected, and therefore the probability computation used in the random decision can be changed accordingly. When the device is connected to a reliable server, the reliability of revocation notices is higher and the probability is therefore allowed to be higher than in other conditions. And when the list is not yet full, the probability used in the random decision for updating the revocation list can be chosen differently, such as close to or equal to 100%.

Which identifier of the local revocation list is to be replaced with the new identifier, can also be chosen randomly.

When it is known that a revoked identifier has been detected in the list during a previous comparison, it can be useful not to replace this revoked identifier.

It is a further object of the invention to provide a system of the kind set forth that further reduces the determinability of the system storing the revocation list.

This object is achieved by a system characterized in that the system further comprises an admission device taking a random decision either to ignore the received new revoked identifier, or to update the local revocation list with the received new revoked identifier.

The system may comprise an access device that controls access to content material. The access device has its own unique identifier, enabling a verification of the access device itself against the local revocation list.

It is a further object of the invention to provide a device of the kind set forth that further reduces the determinability of the device storing the revocation list. The object of the invention is further achieved by a device of the kind set forth characterized in that the device is arranged to take a random decision upon receiving the new revoked identifier either to ignore the received new revoked identifier, or to update the local revocation list with the received new revoked identifier.

It is a further object of the invention to provide a computer program product of the kind set forth that further reduces the determinability of the system executing the computer program and storing the revocation list. The object of the invention is further achieved by a computer program product of the kind set forth characterized in that the computer program product is capable to implement the method as described above.

These and other aspects of the invention will be further described by way of example and with reference to the drawings, wherein:

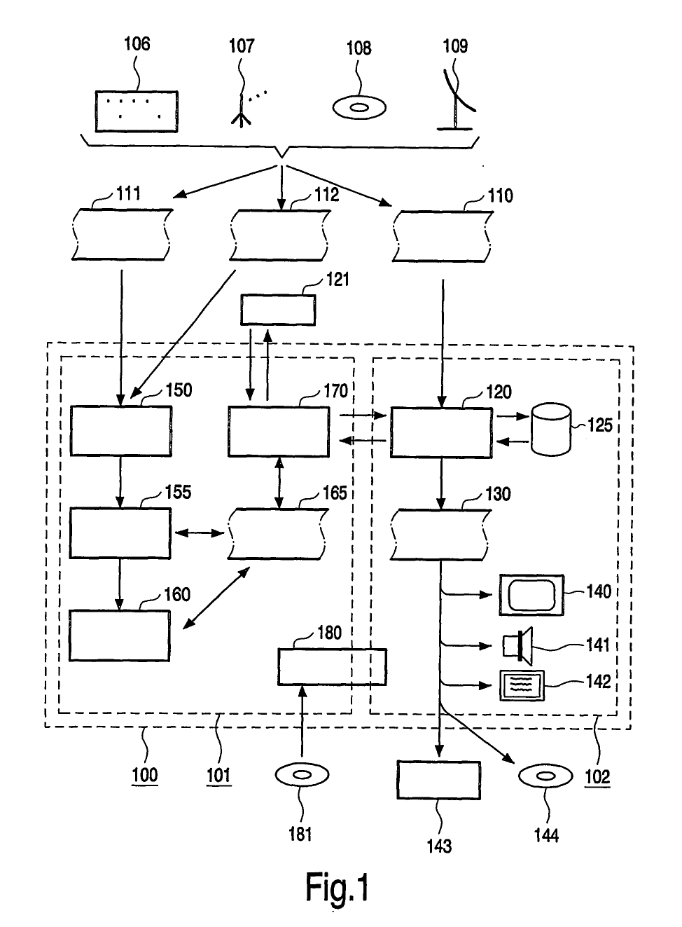

FIG. 1 schematically shows a system for controlling access to content material according to the invention,

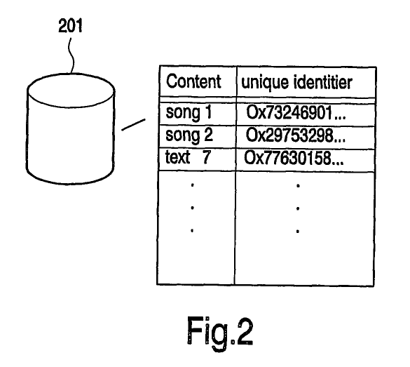

FIG. 2 shows the use of a unique identifier to identify content,

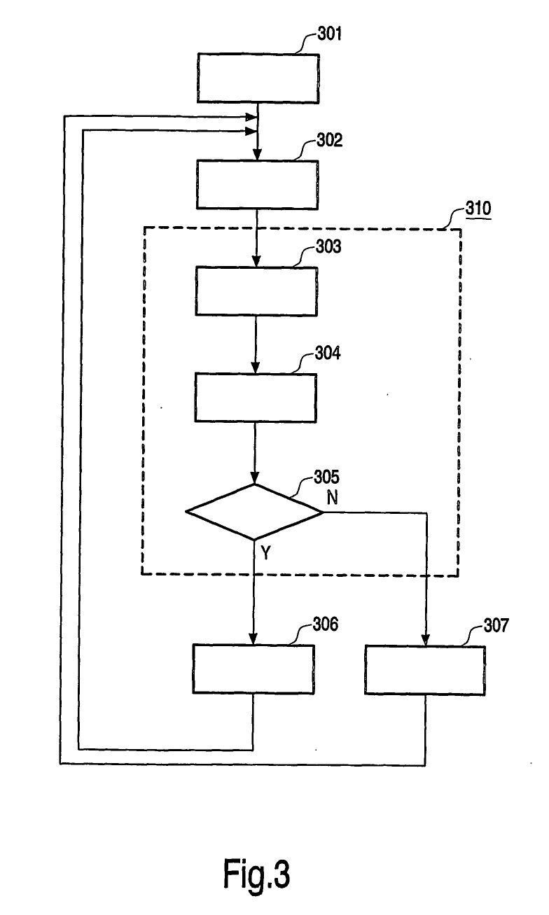

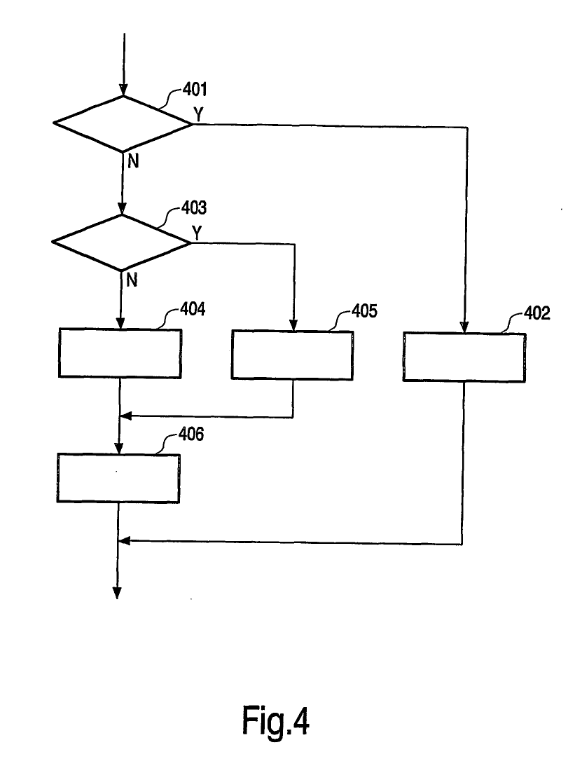

FIGS. 3 and 4 illustrate an example flow diagram for updating a local revocation list according to the invention, and

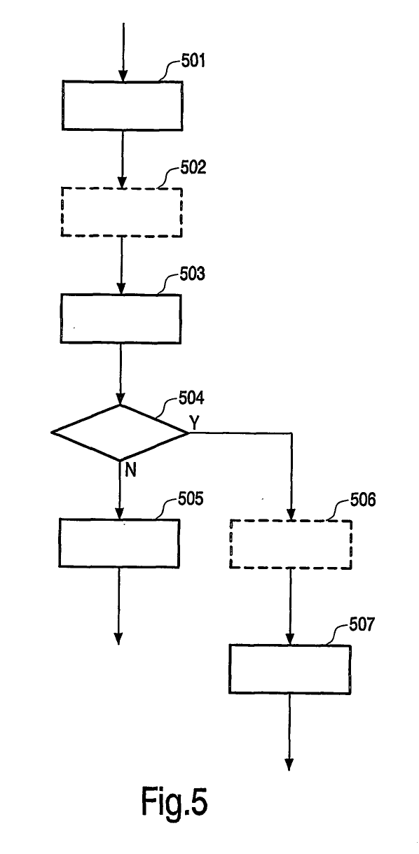

FIG. 5 shows an example flow diagram for the verification of a unique identifier against the local revocation list.

Throughout the figures, same reference numerals indicate similar or corresponding features. Some of the features indicated in the drawings are typically implemented in software, and as such represent software entities, such as software modules or objects.

FIG. 1 schematically shows a system 100. System 100 can be implemented as a dedicated device or as a set of devices. It may contain one or more processing units to implement the required functionality.

The data structures and program instructions for these processing units may be combined with the device(s) or may be stored and/or distributed on a medium 181 such as a CD-ROM. General-purpose devices such as a personal computer or PDA can also be used to implement the invention using a computer program product to distribute the program containing the invention.

The system 100 contains different subsystems 101 and 102.

Subsystem 101 relates to the handling of the local revocation list; subsystem 102 is able to control access to content material 110. Such an access control system 102 typically has an access device 120 that handles content material that can be obtained from different sources, such as a different device 106, local area network 107, physical distribution means such as a DVD disk 108, or a satellite dish 109.

The content material 110 can either be controlled content material or uncontrolled content material. Uncontrolled content material can either be content free of copyright, content from older media types, or content created or provided locally. Controlled content material can be copyrighted movies, copyrighted electronic books, a rented movie, a onetime movie and the like. Controlled content material can be accompanied by rules that specify which operations are allowed, possibly indicating traditional restrictions, such as a maximum number of copies that can be made, or a payment that is required to perform certain actions. For further protection against illegal handling the content material 110 can be (partially) encrypted.

Operations that can be performed by subsystem 102 include processing and rendering. Processing includes actions such as decoding, decrypting, and transcoding but also editing, timeshifting and archiving of content using a storage medium 125 such as a hard disk. Content containing program instructions can be processed by one or more dedicated or general-purpose processing units 180. These actions result in the availability of accessible content 130. This content can be rendered on an output device such as a television screen 140, audio speakers 141, or information display screen 142. This content can also be copied to a physical carrier such as a DVD+RW disk 144, or transmitted to a different device 143 or onto a network.

In order to protect the controlled content, devices in a network that handle controlled content should do so in accordance with certain policy requirements. For example, devices should authenticate each other before communicating content material. This prevents content from leaking to unauthorized devices. Some systems might also refuse to handle data originating from untrusted devices. It is important that devices only distribute content to other devices which they have successfully authenticated beforehand. This ensures that an adversary cannot make unauthorized copies using a malicious device. A device will only be able to successfully authenticate itself if it was built by an authorized manufacturer, for example because only authorized manufacturers know a particular secret necessary for successful authentication or because the devices are provided with a certificate issued by a Trusted Third Party.

However, a device can be hacked or illegally copied by an adversary. An existing solution to cope with these hacked devices is device revocation. In general, revocation of a device is the reduction or complete disablement of one or more of its functions.

For example, revocation of a CE device may place limits on the types of digital content that the device is able to decrypt and use. Alternatively, revocation may cause a piece of CE equipment to no longer perform certain functions, such as making copies, on any digital content it receives.

The usual effect of revocation is that other devices that know that a specific device is revoked will change their behavior towards the revoked device, for example they do not want to communicate anymore with the revoked device. A device may also have been informed that it is revoked itself; if the device consists of different parts some parts that are still complying may change their internal or external behavior accordingly. A device may also contain a processor and software, part of which could have been made more tamperproof (for example by storing its instructions in nonchangeable read-only memory), which implements a self-check in this manner.

Revocation of exactly one device can be done if every device has a unique identifier. This identifier can be for example its public key, but also a different unique identifier that is bound (for example via a certificate) to its public key.

Not only devices can be addressed by the range of unique identifiers. It is possible to identify all sorts of entities by a unique identifier. These other entities can therefore also be revoked in the same manner as devices. For example, the content itself (201) could carry a unique identifier for each song, text file, or picture, for example using a table 202 as shown in FIG. 2. In the sequel, revocation of a device or other entity will be addressed as revocation of an identifier. The identifier itself will be called revoked identifier.

Revocation of an identifier can be achieved in several different manners. Two different techniques are the use of a so-called black list (a list of revoked identifiers) or white list (a list of unrevoked identifiers, or a list of ranges of unrevoked identifiers). A device uses such a revocation list to verify whether an identifier has possibly been revoked.

A revocation list can either be downloaded completely each time it is needed, or downloaded once and be incrementally updated afterwards. Both revocation notices, containing new information about revoked identifiers, as well as complete revocation lists can be communicated to a device via several means, such as the normal communication channels for content, or by a dedicated connection such as a telephone connection, or the Internet.

Subsystem 101 shows a receiver 150 capable of receiving a revocation list 111 or a revocation notice containing a new received revoked identifier 112. When the receiver 150 receives a revocation notice containing a new received revoked identifier 112, it is decided by the admission device 155 whether the new revocation notice should be ignored or handled. For each revocation notice to be handled, a location in the local revocation list 165 is determined by an updater 160.

When a revocation list 111 is received, it is possible to store the revocation list as a whole, but it is also possible to make a selection from the list, especially if the list is larger than the storage available. This selection can be made for example by feeding each revoked identifier in the revocation list to the admission device 155 just like individual revocation notices, but other possibly more efficient approaches are also possible.

The handling of a black list of revoked identifiers will further be discussed in reference to FIG. 3 which shows the flow diagram for maintaining the local revocation list.

In the initial situation 301, a local revocation list is stored. In step 302 a new revoked identifier is received. The invention performs an admission step 310 for each new received revoked identifier. In this step it is decided whether the new received revoked identifier should be ignored, or should be used to update the local revocation list. The admission step comprises a random decision step 304. The probability used in the random decision process is first computed in step 303. Based on the outcome of the random decision, an update step 306 or ignore step 307 is performed. The update step 306 updates the list with the received new revoked identifier. This step will be further illustrated in FIG. 4. Ignore step 307 ignores the received new revoked identifier.

FIG. 4 further illustrates and details the update step 306. Step 401 verifies whether the new revoked identifier is already present in the local revocation list. In that case, the information of the revoked identifier in the list is updated if required with for example a timestamp or other metadata in step 402. Otherwise, a check 403 is made whether free space is available in the local revocation list. If space is available, a free location is selected in step 404. Otherwise, step 405 selects an entry in the local revocation list that is to be replaced by the new revoked identifier. Subsequently, step 406 stores the received new revoked identifier at the selected location.

The verification of a unique identifier is further described in reference with the flow diagram shown in FIG. 5. In step 501 the unique identifier to be verified is received by the verification device. Step 503 searches for this identifier in the local revocation list. Step 504 decides whether a match has been found. If not found, it is assumed and reported in step 505 that the unique identifier has not been revoked. Otherwise, step 507 reports that the unique identifier has been revoked. Optional steps 502 and 506 will be further discussed in the next embodiments.

The use of an additional random decision for deciding whether a list update takes place, decreases the predictability to an outside observer of the content of the local revocation list even more than the prior art as described in U.S. patent WO01/11819. Because the revocation list handling including the random decision is performed locally, different devices may also develop different behavior, possibly adapted to their different local circumstances. It is an additional advantage of the invention that the randomness in the decision cannot be observed from external communications.

In a second embodiment, step 502 remembers the unique identifiers that are being verified. Furthermore, the computation of the probability in this embodiment involves a comparison between the received new revoked identifier and the list of verified unique identifiers. If a match is found, the probability should be increased. The computation of the probability may also involve the unique identifiers of the device and its entities itself and the devices with which it communicates, even if they are not on the list of verified unique identifiers. When a revocation notice concerns the identifier of any of the verified or known devices or entities, it is probably wise not to ignore this revocation. This embodiment has the advantage that the content of the local revocation list is adapted to the local situation.

In a third embodiment, the selection of the identifier in step 405 can be made at random, or based on either information contained in the revocation notice, or information contained in the (entries of the) revocation list.

In a fourth embodiment, step 506 marks the index of a matching revoked identifier as being nonreplaceable. This will prevent the selection of this index in step 405.

This embodiment has the advantage that identifiers that are actually used within or in the neighborhood of the device that performs the verification are not replaced anymore.

In a fifth embodiment, the computation of the probability involves the status or content of the local revocation list. The probability may for example depend on the free space still available. According to the prior art revocation notices shall first fill empty space in the revocation list, but a probability not equal to one, possibly decreasing as the empty space becomes smaller, makes it more difficult for a hacker to determine the size of the storage available for the local revocation list. The probability may also depend on the number of entries in the list that have been marked non-replaceable.

In a sixth embodiment, the computation of the probability involves characteristics of the newly received revoked identifiers. When a flood of new received revoked identifiers is detected, hacker action could be suspected, which could be a reason to reduce the probability.

In a seventh embodiment, the computation of the probability involves the device status. For example, when the device is verifiably connected to a reliable source the probability in the admission decision could be higher than in other cases.

These approaches change the probability of the admission decision and will hence further reduce the predictability and the chances for the hacker.

The above-mentioned embodiments illustrate rather than limit the invention. Those skilled in the art will be able to design many alternative embodiments without departing from the scope of the appended claims. In the claims, any reference signs placed between parentheses shall not be construed as limiting the claim. Alternatives are possible. Instead of a random decision, also pseudo-random processes and other methods for generating unpredictability can be used. In the description above, “comprising” does not exclude other elements or steps, “a” or “an” does not exclude a plurality. A single processor, a suitably programmed computer, hardware comprising several distinct elements, or other unit may also fulfill the functions of several means recited in the claims. The mere fact that certain measures are recited in mutually different dependent claims does not indicate that a combination of these measures cannot be used to advantage.

1. A method of facilitating access control to content,
the method involving entities each being identified by a unique identifier,
the method further involving revocation of at least one unique identifier,
where a revoked unique identifier is further referred to as revoked identifier,
the method comprising maintaining a local revocation list (165) that contains a list of revoked identifiers,
receiving (302) a new revoked identifier (112), and
subsequently conditionally updating (306) the local revocation list with the received new revoked identifier, characterized in that the method further comprises
an admission step (310) including taking a random decision (304) before updating the local revocation list, the decision being
either to ignore (307) the received new revoked identifier,
or to update (306) the local revocation list with the received new revoked identifier.

2. The method according to claim 1, wherein a verification step (501-507) is executed in which
a unique identifier is verified by comparing the unique identifier with the revoked identifiers in the local revocation list (165), and
the unique identifier is considered to be revoked when the comparison finds a match between
the unique identifier and
one of the revoked identifiers in the local revocation list, further to be referred to as the matching identifier.

3. The method according to claim 2, wherein
the unique identifier being verified is stored in a list of verified unique identifiers, and
the random decision in the admission step (310) has a probability depending on a match of the new received revoked identifier with one of
the list of verified unique identifiers,
unique identifiers known to be used within the device, and
unique identifiers known to be used in neighboring devices.

4. The method according to claim 1, wherein the random decision in the admission step (310) has a probability depending on at least one of:
characteristics of the received new revoked identifier,
characteristics and status of the local revocation list, and
device status

5. The method according to claim 1, wherein the method further comprises a selection step (405) in which a revoked identifier from the local revocation list which is going to be replaced is chosen randomly from the local revocation list.

6. The method according to claim 5, wherein the matching identifier is excluded from replacement during the selection step (405).

7. A system (100) for controlling access to content material (110), the system comprising
a local revocation list (165) that contains a list of revoked identifiers,
a receiver (150) for receiving a new revoked identifier (112), and
an updater (160) for conditionally updating the local revocation list with the received new revoked identifier, characterized in that
the system further comprises an admission device (155) arranged to take (304) a random decision
either to ignore (306) the received new revoked identifier,
or to update (307) the local revocation list with the received new revoked identifier.

8. The system according to claim 7, in which the system further comprises
an access device (120) for controlling access to content material (110),
the access device being identified by a unique identifier,
the access of the access device to the content material is not being allowed if a match is found between
the unique identifier of the access device, and
an entry in the local revocation list (165).

9. A device arranged
to store and maintain a local revocation list (165) that contains a list of revoked identifiers, and
to receive a new revoked identifier (112), characterized in that the device
is arranged to take (304) a random decision upon receiving the new revoked identifier
either to ignore (306) the received new revoked identifier (112),
or to update (307) the local revocation list with the received new revoked identifier.

10. A computer program product (181) capable to implement the method according to claim 1.
